(19) United States
(12) Patent Application Publication
(10) Pub. No.: US 2026/0149716 A1
(43) Pub. Date: May 28, 2026

(54) MULTI-TENANT APPLICATION COMMUNICATION SECURITY ENFORCEMENT

(71) Applicant: Stripe, Inc., South San Francisco, CA (US)

(72) Inventors: Tushar Dhoot, South San Francisco, CA (US); Aaltan Ahmad, South San Francisco, CA (US); Vivian Tsai, South San Francisco, CA (US)

(73) Assignee: Stripe, Inc., South San Francisco, CA (US)

(21) Appl. No.: 18/957,447

(22) Filed: Nov. 22, 2024

(51) Int. Cl. H04L 9/40

(52) U.S. Cl. CPC H04L 63/102; H04L 63/0245; H04L 63/20

(57) ABSTRACT

Disclosed herein are methods and systems for secure, tenant-specific access control within a multi-tenant application infrastructure. A server can process a request from one tenant application and send it through one or more intermediary tenant applications before reaching its final destination. The server can create a data packet that includes information about the original sender, any intermediate applications it passed through, and details about the requested resource. This packet is then sent through a separate channel to the final tenant application so that the final tenant application can evaluate contextual data (in addition to the request itself) before determining whether to allow or block the request. This paradigm may enable tailored security protocols, improving both data protection and regulatory compliance, even when requests involve multiple disparate computing infrastructures.

### TECHNICAL FIELD

This application relates generally to methods and systems to secure communication among tenant applications in computing infrastructure.

### BACKGROUND

In multi-tenant computing infrastructures, multiple applications, known as “tenants” or “tenant applications” operate within a shared environment and frequently interact to access resources, perform transactions, or retrieve data. While this structure enables efficient use of resources, it also creates challenges for security and compliance, especially when requests pass through multiple tenants before reaching their final destination. In conventional systems, requests originating from one tenant and/or computing systems may pass through various intermediary tenants without retaining essential contextual information, such as the identity of the originating tenant or the request's intended purpose. This lack of information prevents downstream applications from enforcing specific security or compliance policies based on the request's full history, thus limiting the ability to implement fine-grained access controls.

### SUMMARY

For the aforementioned reasons, there is a need to provide secure intra-tenant communication among different tenant applications or with downstream applications. Traditional approaches to address these technical challenges often involved shifting to service-oriented architectures where each tenant operates independently. However, many organizations maintain multi-tenant infrastructures to optimize resources and ensure compatibility, creating a need for technical solutions that enable detailed visibility and control across tenant interactions.

The methods and systems discussed herein address these technical challenges by introducing a method in which a server generates a data packet with essential metadata, including unique tenant identifiers and resource attributes, that travels with each request through the infrastructure. By transmitting this metadata through a dedicated communication channel, downstream applications can evaluate the request based on the full path history and apply tenant-specific security and compliance policies, thus improving security, regulatory compliance, and operational efficiency in multi-tenant environments.

By including detailed information about where each request comes from and how it travels, the methods and systems discussed herein allow applications to check and enforce specific security rules for each tenant. This helps prevent unauthorized access and makes the system safer overall.

Using the methods and systems discussed herein, a server can track/monitor tenant interactions closely, helping to meet regulatory requirements for data access and control. This allows applications to make access decisions in real-time or near-real time, ensuring they are able to follow compliance standards across all tenant activities. Implementing the methods and systems discussed herein also may eliminate the need for repetitive security steps or broad access permissions. This makes the process faster and uses fewer resources, saving time and reducing workload. Using the methods and systems discussed herein also generate a safer and more secure communication paradigm between computing systems and their corresponding tenants.

In some aspects, the techniques described herein relate to a method for enabling blocking fraudulent requests in multi-tenant application computing infrastructure, the method including: receiving, by at least one processor hosting a multi-tenant application computing infrastructure, from a first tenant application of the multi-tenant application computing infrastructure, a request to access a second tenant application through an intermediary tenant application within the multi-tenant application computing infrastructure, wherein each tenant application within the multi-tenant application computing infrastructure includes a unique identifier; transmitting, by the at least one processor via a first communication channel, the request to the intermediary tenant application and the second tenant application; generating, by the at least one processor, a data packet including metadata associated with a first unique identifier of the first tenant application, a second unique identifier of the intermediary tenant application, and at least one attribute of at least one resource associated with the request; and transmitting, by the at least one processor via a second communication channel, the data packet to the second tenant application, enabling the second tenant application to determine whether to block the request by evaluating the metadata in the data packet using one or more tenant-specific security protocols.

In some aspects, the techniques described herein relate to a method, further including: forwarding, by the processor, the data packet to at least one subsequent tenant application accessed by the first tenant application via the request.

In some aspects, the techniques described herein relate to a method, further including: generating, by the processor, a compliance log including the data packet and at least one action executed by the first tenant application.

In some aspects, the techniques described herein relate to a method, wherein the data packet further includes a sensitivity attribute associated with the first tenant application, and wherein the second tenant application blocks the first tenant application from accessing at least one resource in accordance with the sensitive attribute.

In some aspects, the techniques described herein relate to a method, wherein the second tenant application is associated with a second multi-tenant application computing infrastructure.

In some aspects, the techniques described herein relate to a method, wherein the data packet is dynamically updated at runtime, thereby allowing accommodation to real-time changes in tenant permission.

In some aspects, the techniques described herein relate to a method, wherein the second communication channel is a secure application programming interface communication protocol that is not used by the tenant applications within the multi-tenant application computing infrastructure.

In some aspects, the techniques described herein relate to a computer system for enabling blocking fraudulent requests in multi-tenant application computing, the computer system including a computer-readable medium having instructions that when executed, cause a processor to: receive from a first tenant application of a multi-tenant application computing infrastructure, a request to access a second tenant application through an intermediary tenant application within the multi-tenant application computing infrastructure, wherein each tenant application within the multi-tenant application computing infrastructure includes a unique identifier; transmit, via a first communication channel, the request to the intermediary tenant application and the second tenant application; generate a data packet including metadata associated with a first unique identifier of the first tenant application, a second unique identifier of the intermediary tenant application, and at least one attribute of at least one resource associated with the request; and transmit, via a second communication channel, the data packet to the second tenant application, enabling the second tenant application to determine whether to block the request by evaluating the metadata in the data packet using one or more tenant-specific security protocols.

In some aspects, the techniques described herein relate to a computer system, wherein the instructions further cause the processor to forward the data packet to at least one subsequent tenant application accessed by the first tenant application via the request.

In some aspects, the techniques described herein relate to a computer system, wherein the instructions further cause the processor to generate a compliance log including the data packet and at least one action executed by the first tenant application.

In some aspects, the techniques described herein relate to a computer system, wherein the data packet further includes a sensitivity attribute associated with the first tenant application, and wherein the second tenant application blocks the first tenant application from accessing at least one resource in accordance with the sensitive attribute.

In some aspects, the techniques described herein relate to a computer system, wherein the second tenant application is associated with a second multi-tenant application computing infrastructure.

In some aspects, the techniques described herein relate to a computer system, wherein the data packet is dynamically updated at runtime, thereby allowing accommodation to real-time changes in tenant permission.

In some aspects, the techniques described herein relate to a computer system, wherein the second communication channel is a secure application programming interface communication protocol that is not used by the tenant applications within the multi-tenant application computing infrastructure.

In some aspects, the techniques described herein relate to a computer system for enabling blocking fraudulent requests in multi-tenant application computing, the computer system including: a multi-tenant application computing infrastructure; a processor configured to host the multi-tenant application computing infrastructure, the processor configured to: receive from a first tenant application of the multi-tenant application computing infrastructure, a request to access a second tenant application through an intermediary tenant application within the multi-tenant application computing infrastructure, wherein each tenant application within the multi-tenant application computing infrastructure includes a unique identifier; transmit, via a first communication channel, the request to the intermediary tenant application and the second tenant application; generate a data packet including metadata associated with a first unique identifier of the first tenant application, a second unique identifier of the intermediary tenant application, and at least one attribute of at least one resource associated with the request; and transmit, via a second communication channel, the data packet to the second tenant application, enabling the second tenant application to determine whether to block the request by evaluating the metadata in the data packet using one or more tenant-specific security protocols.

In some aspects, the techniques described herein relate to a computer system, wherein the processor is further configured to forward the data packet to at least one subsequent tenant application accessed by the first tenant application via the request.

In some aspects, the techniques described herein relate to a computer system, wherein the processor is further configured to generate a compliance log including the data packet and at least one action executed by the first tenant application.

In some aspects, the techniques described herein relate to a computer system, wherein the data packet further includes a sensitivity attribute associated with the first tenant application, and wherein the second tenant application blocks the first tenant application from accessing at least one resource in accordance with the sensitive attribute.

In some aspects, the techniques described herein relate to a computer system, wherein the second tenant application is associated with a second multi-tenant application computing infrastructure.

In some aspects, the techniques described herein relate to a computer system, wherein the data packet is dynamically updated at runtime, thereby allowing accommodation to real-time changes in tenant permission.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate embodiments of the subject matter disclosed herein.

FIG. 1 illustrates a multi-tenant application computing infrastructure, according to one or more embodiments.

FIG. 2 illustrates a multi-tenant application computing infrastructure, according to one or more embodiments.

FIG. 3 illustrates a non-limiting example of a multi-tenant application computing infrastructure implementing the methods discussed herein, according to one or more embodiments.

FIG. 4 illustrates a block diagram of implementing secure communication among tenant applications, according to one or more embodiments.

FIG. 5 is a component diagram of an example computing system suitable for use in the various implementations described herein, according to an example embodiment.

### DETAILED DESCRIPTION

Reference will now be made to the illustrative embodiments illustrated in the drawings, and specific language will be used here to describe the same. Nevertheless, it will be understood that no limitation of the scope of the claims or this disclosure is intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

Disclosed herein are methods and systems for secure, tenant-specific access control within a multi-tenant application infrastructure. In an example, a server can process a request from one tenant application and send it through one or more intermediary tenant applications before reaching its final destination. The server can create a data packet that includes information about the original sender, any intermediate applications it passed through, and details about the requested resource. This packet is then sent through a separate channel to the final tenant application so that the final tenant application can evaluate contextual data (in addition to the request itself) before determining whether to allow or block the request. This paradigm may enable tailored security protocols, improving both data protection and regulatory compliance, even when requests involve multiple disparate computing infrastructures.

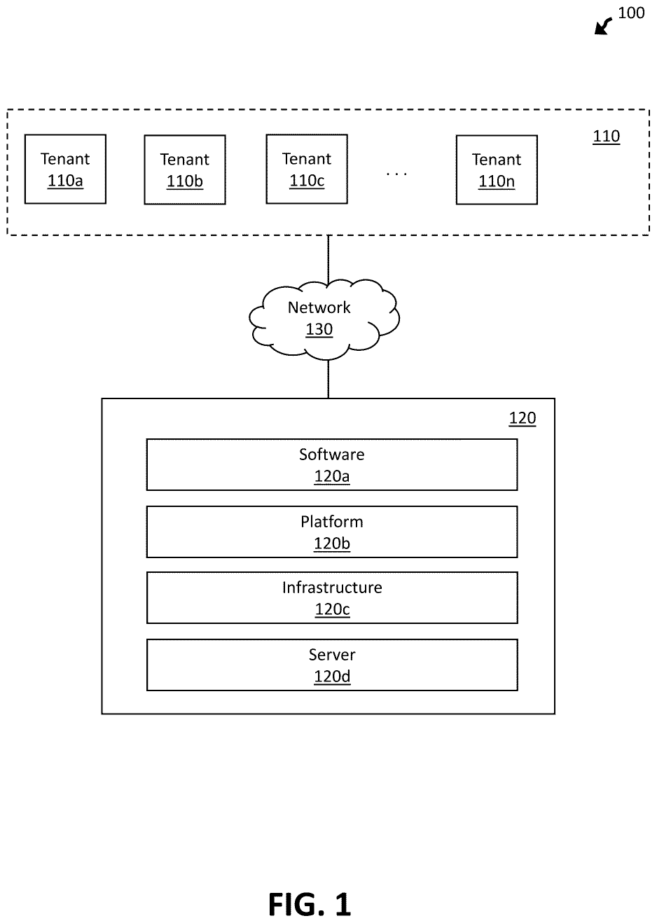

FIG. 1 illustrates a multi-tenant computing system where several applications, also referred to as “tenants” or “tenant applications,” operate within a shared computing infrastructure. In this non-limiting example, tenant applications can send requests to each other to access resources or perform actions. FIG. 1 illustrates that a host server can play a central role by managing and monitoring these requests as they are transmitted among different tenants. To ensure secure and compliant processing, the host server can generate a “data packet” with metadata about each request that can provide contextual data needed for a tenant application to make an informed decision regarding whether a request is fraudulent or inappropriate. The data packet can include information about which tenant originated the request, any intermediaries it passed through, and details about the requested resource. The data packet can be transmitted via a separate and secure communication channel to the recipient tenant. The data packet can be used to create a more secure computing environment. Effectively, the data packet can be used by the downstream tenant or the recipient tenant, in conjunction with existing security protocols, to ensure that requests are properly evaluated in accordance with tenant-specific rules. This enables precise, tenant-specific security and compliance enforcement, reducing the risk of unauthorized access and enhancing regulatory adherence across complex, multi-tenant environments.

As shown in FIG. 1, a multi-tenant application computing infrastructure 100 is depicted. The multi-tenant application computing infrastructure 100 may generally be considered implemented as a cloud computing environment, an on-premises (“on-prem”) computing environment, or a hybrid computing environment including one or more on-prem computing environments and one or more cloud computing environments. When implemented as a cloud computing environment, also referred to as a cloud environment, cloud computing, or cloud network, the multi-tenant application computing infrastructure 100 can provide the delivery of shared services (e.g., computing services) and shared resources (e.g., computing resources) to multiple nodes (otherwise referred to as tenants or tenant applications). For example, the multi-tenant application computing infrastructure 100 can include an environment or system for providing or delivering access to a plurality of shared services and resources to a plurality of users through a network (e.g., the Internet). The shared resources and services can include, but are not limited to, networks, network bandwidth, servers, processing, memory, storage, applications, virtual machines, databases, software, hardware, analytics, computing models (e.g., machine learning models), and the like.

In some embodiments, the multi-tenant application computing infrastructure 100 may include one or more tenant applications, such as tenants 110a-110n (collectively referred to as tenant applications 110). The tenant applications 110 may be in communication with one or more networks 130 in order to communicate with the server 120 and/or other tenant applications.

As used herein, the tenant applications 110 may represent distinct applications or services within the multi-tenant application computing infrastructure 100, where each tenant application can function as an independent entity or software application. Each tenant application may be associated with a unique identifier, enabling individualized management of access control, security policies, and compliance requirements within the shared infrastructure.

The tenant applications 110 may include various types of functionalities or roles specific to their purpose within the multi-tenant application computing infrastructure 100. For example, one tenant application may handle payment processing, while another manages invoicing, and yet another performs user authentication. In a non-limiting example, the tenant 110a (first tenant) may be in charge of executing a machine learning model where the data needed to execute the machine learning model may be queried from the tenant 110b (intermediary tenant). The results of the execution of the machine learning model may then be written in a database managed by the tenant 110c (the second tenant or the destination tenant).

In some embodiments, despite operating within the same infrastructure, each tenant application may maintain operational independence, allowing them to coexist while adhering to specific, tenant-level policies. Accordingly, if a tenant application requires access to a destination or secondary tenant application, the tenant application can issue a request to access the destination/secondary tenant. The receiving tenant application may evaluate the request in accordance with a set of pre-defined rules and determine whether to grant access or block the request. In some embodiments discussed herein, the host 120 may facilitate the communication among different tenant applications and/or other downstream applications that may or may not belong to the multi-tenant application computing infrastructure 100.

The multi-tenant application computing infrastructure 100 may include a host 120. The host 120 may include back-end platforms, e.g., servers, storage, server farms, or data centers. For example, the host 120 can include or correspond to a server or a system remote from one or more tenant applications 110 to provide control over a pool of shared services and resources and further provide control on how different tenant applications access resources managed by other tenant applications. Using the host 120, the multi-tenant application computing infrastructure 100 can provide resource pooling to serve multiple tenant applications with different physical and virtual resources dynamically assigned and reassigned responsive to their different unique rules and compliance protocols.

The multi-tenant application computing infrastructure 100 can provide a single instance of Software, an application, or a software application to serve multiple users/tenants. In some embodiments, the multi-tenant application computing infrastructure 100 can provide on-demand self-service to unilaterally provision computing capabilities (e.g., server time, network storage) across a network for multiple tenant applications. In some embodiments, the host 120 can generate reports corresponding to the provided shared services and resources. For instance, the host 120 may generate access and/or activity logs that can be monitored and audited retroactively.

In some embodiments, the host 120 may include a cloud-based delivery, e.g., Software as a Service (SaaS) 120a, Platform as a Service (PaaS) 120b, and Infrastructure as a Service (IaaS) 120c. In some embodiments, SaaS 120a may offer additional resources, including e.g., data and application resources, data storage providers, and the like. In some embodiments, the PaaS 120b may offer functionality provided by IaaS, including, e.g., storage, networking, servers, or virtualization, as well as additional resources such as, e.g., the operating system, middleware, or runtime resources. In some embodiments, the IaaS 120c may refer to a tenant application temporarily using the infrastructure resources that are needed during a specified time period. The host 120d may offer storage, networking, servers, or virtualization resources from large pools to different tenant applications 110.

In some embodiments, access to IaaS, PaaS, or SaaS resources may be authenticated by the server 120d. For example, the server 120d may authenticate and evaluate a request issued by a tenant application. The server 120d may be responsible for processing, monitoring, and enforcing security and compliance policies for requests originating from different tenant applications.

In some embodiments, upon receiving a request from a tenant application, the server 120d may identify and extract metadata associated with the request. The extracted metadata may include a unique identifier for the originating tenant and any other intermediary tenant applications. The extracted metadata may also include information related to the request's purpose (e.g., the identifier of the resources needed, a description of what the end result will be), sensitivity level (e.g., whether the operations will need to access sensitive or PII data), and any other compliance-relevant attributes (e.g., a description regarding the end result).

The server 120d may then generate a data package that encapsulates this metadata, creating a structured record of the request that can be forwarded along with the request to downstream tenant applications and/or other computing infrastructures.

In some embodiments, the data packet can be transmitted to the destination tenant application via a secondary communication channel. Using this data package, the server 120d and/or the destination tenant may evaluate the request in accordance with one or more tenant-specific security protocols. For instance, in some embodiments, the destination tenant application (also referred to herein as the second tenant) may apply a predefined set of rules to evaluate the request and/or the data packet. In this way, the second tenant application may ensure that only authorized tenants can access specific data, perform certain actions, or otherwise use resources controlled by the second tenant application.

In some embodiments, the server 120d is configured to operate in two modes. In a first configuration, the server 120d may operate in a “logging mode,” which records the request for auditing purposes. In logging mode, the server 120d may periodically record requests transmitted among different tenant applications (and associated metadata). Effectively, the server 120d may capture details of all requests (e.g., the identifier of the originating tenant, request purpose, and other data). The logging mode allows a compliance or security manager to retroactively analyze the requests without interfering with the data flow. The server 120d may then periodically transmit the logs to a different server for auditing purposes.

In a second configuration, the server 120d may operate in a “preventative mode,” which actively blocks (by the server 120d or the destination tenant) unauthorized access or requests. In the preventative mode, the server 120d actively evaluates each request from tenant applications. In some embodiments, the server 120d may actively block access itself. Additionally, or alternatively, the server 120d may transmit the data packets discussed herein in order to allow the destination tenant application to block access itself.

In some embodiments, the server 120d may act as the central processing and enforcement entity within the multi-tenant application computing infrastructure 100, enabling fine-grained control, visibility, and compliance for each tenant application operating within the shared environment.

In some embodiments, the tenant applications 110 may interact with each other through different application programming interfaces (APIs). For instance, each tenant application may operate independently, with a unique identifier, and may initiate one or more API requests to perform various actions, such as accessing shared resources, retrieving data, or invoking specific functions hosted by other tenant applications. These API requests may be transmitted over the network 130. The server 120d may then monitor and manage these API requests in real-time (or near real-time), leveraging the metadata embedded in each request. As each API request is initiated by a tenant application, the server 120d may intercept the request data, extracting the unique identifier of the originating tenant along with relevant metadata, such as the purpose, resource type, and sensitivity level associated with the request. This metadata enables the server 120d to associate each API call with a specific tenant application and to differentiate between tenant applications.

Using the extracted data, the server 120d may then generate the data packets discussed herein. The server 120d can then apply tenant-specific security and compliance protocols to each API request in order to block unauthorized access to downstream tenant applications. In logging mode, the server 120d may record each API request and its associated metadata without altering or blocking the request, creating a comprehensive log for audit purposes. Alternatively, the server 120d can transmit the data packet via a different communication channel to the destination tenant, thereby allowing the destination tenant application to evaluate the request.

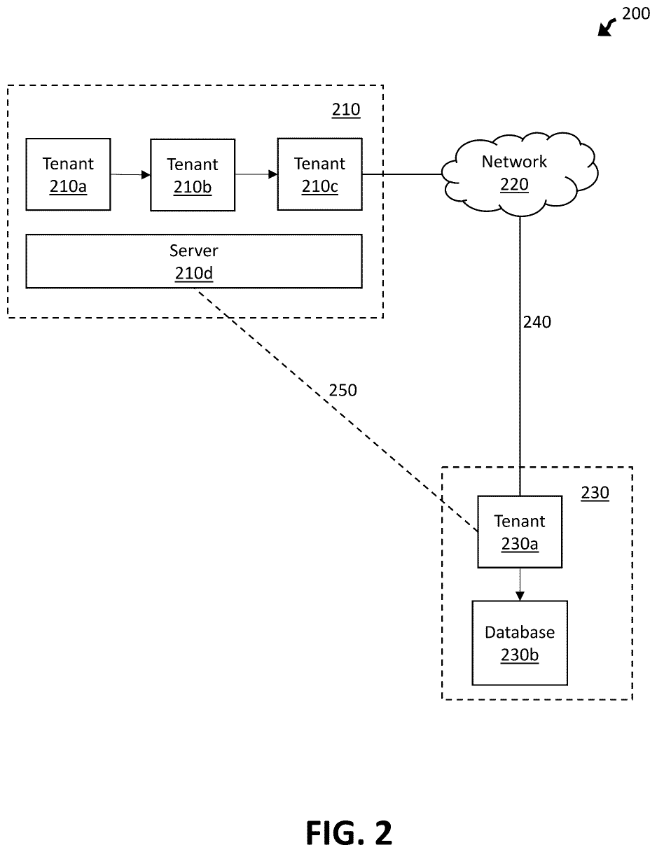

In some embodiments, the downstream tenant application may be a part of a different computing infrastructure. This may limit the downstream application's ability to appropriately evaluate a request. FIG. 2 illustrates how this technical challenge may cause delayed or inaccurate security analysis of requests. For instance, different tenant applications in a computing infrastructure (e.g., computing infrastructure 210) may serve distinct purposes and may be managed by different owners. Each tenant application may need to interact with other applications or access external resources, like databases, to read or modify data. However, because these requests are made from within a single shared infrastructure, downstream systems (computing infrastructure 230 in this embodiment) can only identify the requests as originating from that infrastructure as a whole. Accordingly, downstream tenant applications may lack detailed information about which specific tenant initiated the request, making it technically challenging to enforce security and compliance requirements specific to each tenant.

For instance, within a system, such as the computing infrastructure 210 (e.g., an entity's API system that serves API requests), various tenants may execute specific functions for different products. One tenant might initiate payments (e.g., tenant 210b), while another tenant (e.g., 210c) may create invoices. Each of these tenants may have unique security and compliance requirements (e.g., the payments tenant may be authorized to access payment systems and databases, while the invoice tenant may be permitted to access the invoice database but not the payment systems). However, since downstream systems only see requests as being transmitted from the computing infrastructure 210 in general, they cannot distinguish between these tenants or apply tailored security and compliance checks, thus limiting the ability to enforce tenant-specific policies. FIG. 2 illustrates how the methods discussed herein can use separate transmittal of data packets to allow the downstream tenant to properly evaluate received requests. In the depicted embodiment (a system 200), the computing infrastructure 210 is similar to the multi-tenant application computing infrastructure 100 (e.g., the server 210d is similar to the server 120d, and the tenants 210a-c are similar to the tenants 110).

The system 200 provides a non-limiting example of how the secure communication methods discussed herein can be implemented. In the depicted embodiment, the tenant 210c requests access to a tenant application (downstream application) that belongs to a different computing infrastructure. For instance, the tenant application 230a is hosted with a secondary computing infrastructure 230 (e.g., separate from the primary multi-tenant computing infrastructure 210).

In conventional systems, when tenant application 230a receives a request from tenant application 210c, the tenant application 230a does not receive any contextual metadata indicating the origin of the request received. Specifically, in those embodiments, the tenant application 230a may lack information on how the request originated from tenant application 210a and was subsequently routed through tenant application 210b before reaching tenant 210c.

This lack of comprehensive contextual metadata causes a security issue in the tenant application 230a by preventing the tenant application from accurately assessing and verifying the request's security or compliance posture. Therefore, fraudsters and bad actors can leverage this security issue to inappropriately access resources managed by the tenant 230a (e.g., the database 230b) by masking or spoofing the originating tenant application.

Using the methods discussed herein, the server 210d can actively monitor API calls among the tenants 210a-c. For instance, the server 210d can determine that the tenant 210a issues a request to be granted access to the database 230b via intermediary nodes (e.g., tenants 210b and 210c). The request is then transmitted (e.g., by the server 210d) to the tenants 210b and 210c. Implementing the methods discussed herein (e.g., the system 200) enhance network security by enabling tenant-specific access control to request through detailed contextual metadata. By transmitting this contextual metadata through a separate secure channel, the system 200 mitigates unauthorized access risks and ensures compliance with security protocols across multi-tenant infrastructures, regardless of where the request is issued.

Using the methods and systems discussed herein, the server 210d may generate a data packet that includes metadata associated with the request. The data packet may include contextual metadata to enable tenant application 230a to make an informed access control decisions. For instance, the data packet may include a unique identifier for the originating tenant application 210a, marking it as the original source of the request, along with identifiers for intermediary tenant applications such as tenant 210b and tenant 210c. This provides a full path history of the request, allowing tenant application 230a to generate an informed blocking decision. In some embodiments, the data packet may include an identifier of the data modifications or execution by the intermediary tenant applications as well.

Additionally, the data packet may further include metadata describing the purpose of the request, such as whether it involves data retrieval, modification, or deletion. The data packet may also include an identifier of the category of data being stored in the database 230b (or at least requested by the tenant 210a). The data packet may also include a sensitivity attribute indicating if the data or action involved is classified as sensitive in accordance with one or more defined rules. Additionally, the data packet may include a timestamp and any relevant sequence data, allowing tenant 230a to track the timing of the request and detect any unusual patterns, if applicable.

The original request issued by the tenant 210a may be transmitted to the tenant 230a via a first communication channel 240. When received, the tenant 230a may merely determine that the request was received from the tenant 210c and may not identify any contextual data associated with the request. The server 210d may then transmit the data packet using a separate communication channel to the tenant 230a (the channel 250). The channel 250 may be a separate/secondary communication channel (than the one used to transmit the request from the tenant application 210c to tenant application 230a). The data packet may include a unique identifier associated with the request, such that the tenant 230a can match the data packet (received via the communication channel 250) with the request received from the tenant 210c (via the communication channel 240).

The separate/secondary communication channel may be implemented as a secure side channel or equivalent protocol and may be dedicated to transmitting data packets associated with requests. This separate communication channel may be used to ensure that sensitive information related to the request's origin and pathway remains isolated from the main data flow. By using a separate communication channel, the server 210d can deliver critical contextual information without affecting the primary request's content or structure.

By transmitting the data packet via a different communication channel, the server 210d may be able to maintain a clean separation of context and data, improving both data integrity and processing efficiency in distributed infrastructures. The use of a separate communication channel may further enhance network security by reducing the risk of tampering with or interception of sensitive metadata during transmission, thus providing a robust paradigm for maintaining context and control in a multi-tenant environment spanning different computing infrastructures.

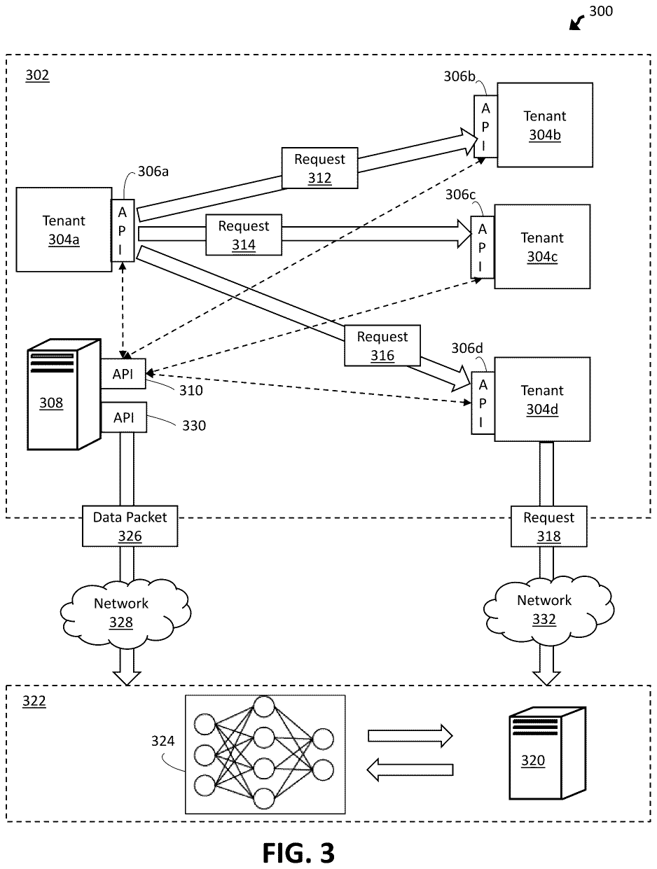

Referring now to FIG. 3, a non-limiting example illustrates how a multi-tenant application computing infrastructure of a system 300 can implement the methods discussed herein to create a secure communication method for different tenant applications. Multiple tenant applications can communicate with each other to evaluate an electronic transaction where different tenant applications perform at least a part of the evaluation under the instructions of an issuing tenant application. The tenant applications then use a downstream computing infrastructure (having a machine learning model) to evaluate the electronic transaction. Specifically, in the system 300, a tenant application 304a receives an indication that a merchant computer (e.g., a point-of-sale system) has requested a transfer of an amount from a user account to a merchant account. The request may also include a transaction amount and a user card identifier (e.g., credit card number). As described herein, the tenant 304a may then be tasked with evaluating the electronic transaction and determining a likelihood of fraud before the transaction is executed. Specifically, the tenant application 304a may be instructed to use a machine learning model (e.g., machine learning model 324) to evaluate the requested transaction.

As depicted, the machine learning model 324 may be functionally operated by a different computing infrastructure. Specifically, the tenant 304a may be a part of a computing infrastructure 302 and the machine learning model 324 may be a part of another computing infrastructure 322. The system 300 depicts how the methods discussed herein can be implemented to allow for multiple tenants to securely communicate with each other. Moreover, the system 300 depicts how a server can improve secure communication between two disparate computing infrastructures (computing infrastructures 302 and 322). For instance, as described herein, the server 308 can ensure that the server 320 has the proper contextual information to evaluate requests received from the computing infrastructure 302 (e.g., request 318).

To increase efficiency and increase security, as discussed in FIGS. 1-2, the tenant application 304a may be programmed to work with other tenant applications within the computing infrastructure 302. As will be discussed, the tenant applications are separated to reduce cross-pollination of data. The tenant application 304a may generate sub-tasks to achieve the objective where different sub-tasks are performed by different tenant applications. For instance, the tenant application 304a may instruct another tenant application (tenant application 304b) to query/retrieve data associated with the user and instruct the tenant application 304c to query/retrieve data associated with the merchant. After the tenants 304b and 304c have retrieved the requested data, the tenant application 304a may instruct the tenant application 304d to request the data to be analyzed by the machine learning model 324. The machine learning model 324 may be in communication with one or more servers (e.g., a server 320), such that the one or more servers can evaluate data before the data is ingested by the machine learning model 324. For instance, the server 320 may use a variety of compliance and network security rules to determine whether a request (and the accompanying data) is going to ultimately compromise the integrity of the machine learning model 324. The evaluation of the data may be performed in order to shield the machine learning model 324 from unauthorized requests. In one example, the server 320 may evaluate a request to determine whether the requesting tenant application is authorized to access the machine learning model 324. In another example, the server 320 may evaluate the data before it is ingested by the machine learning model 324 in order to ensure that the data will not affect the machine learning model 342. For instance, the server 320 may evaluate the data to ensure that the data is not incomplete or will not change the model's accuracy or drift metrics.

Unlike conventional systems where the server 320 is limited to evaluating the received request, the methods discussed herein can provide additional contextual data, such that the server 320 can properly evaluate the received request. For instance, as will be described, the request 318 may not include all the needed information for the server 320 to determine whether the request 318 includes malicious or false data that is provided to the machine learning model 324 or breaches any network security protocols. In some conventional paradigms, the request 318 may not indicate any data associated with how the transaction was conducted, which tenant applications were involved (upstream data), how the data was queried, and what the data (to be ingested by the machine learning model 324) includes. Using the methods discussed herein, a separate data packet 326 can be sent to the server 320 using a separate/isolated electronic communication channel to solve the above-identified technical challenges. The data packet 326 may include the data needed for the server 320 to make an informed decision regarding whether the request 318 is legitimate. The creation of the data packet 326 may improve network security by shielding the machine learning model 324 from unauthorized and/or improper access.

In the system 300, the computing infrastructure 302 includes tenant applications 304a-d (collectively referred to as the tenant applications 304). For clarity and ease of description, only four tenant applications are depicted in the system 300. However, other embodiments may include more or fewer tenant applications. The tenant applications 304 may be any software module or software applications, as discussed herein. Therefore, the tenant applications 304 may be similar to the tenant applications 110 (discussed in FIG. 1). The computing infrastructure 302 also includes a server 308 (similar to the server 120d discussed in FIG. 1) that is configured to generate data packets and monitor how different tenant application communicate.

The tenant applications 304 may use a variety of communication protocols to communicate with each other. For instance, the tenant applications 304 may use dedicated APIs 306a-d (collectively referred to as APIs 306). The APIs 306 may be used in order to ensure intra-communication safety as requests are transmitted among different tenant applications. For instance, the APIs 306 may use security protocols that recognize other authorized APIs (APIs used by other tenants within the computing infrastructure 302), such that unauthorized access is denied. The APIs 306 may also be in communication with a dedicated API associated with the server 308 (API 310). As described, the API 310 may communicate with the APIs 306 such that the API 310 can collect data communicated among different tenant applications.

In the depicted example, the tenant 304a is tasked with determining whether an electronic transaction is fraudulent using a machine learning model that belongs to a downstream computing infrastructure. As a result, the tenant application 304a issues multiple requests to tenant applications 304b, 304c, and 304d in order to gather data needed to efficiently execute the machine learning model from the downstream computing infrastructure.

As depicted, the tenant application 304a transmits a request 312 (via the API 306a and 306b) for the tenant application 304b. The request 312 may require the tenant 304b to query and retrieve attributes of a user issuing the transaction request, such as user identifier, and past transaction history, declined transaction history, user profile information, and the like. The tenant application 304a may also issue a request 314 (via the API 306a and 306c) for the tenant application 304c. The request 314 may require the tenant 304c to query and retrieve data associated with the merchant associated with a transaction, such as a merchant profile, payment history, declined transactions, the history of known cyber-attacks, transaction volume, and the like.

The tenant application 304a may issue the request 312 and 314 separately in order to eliminate cross-pollination of the data needed. For instance, the tenant application 304b may have access to customer profile and customer data. However, the tenant application 304b may not be authorized to access databases storing merchant data, which is only accessible to the tenant application 304c. In another example, one or more databases accessible to the tenant application 304b may include personally identifiable information associated with different customers, which is protected from being accessed by other tenants (e.g., the tenant application 304c).

The tenant application 304a may also issue a request 316 (via the API 306a and 306d) for the tenant application 304d. The request 316 may require the tenant 304d to transmit the customer information (retrieved by the tenant application 304b) and the merchant information (retrieved by the tenant application 304c) to a machine learning model configured to detect a likelihood of transaction fraud. As a result, the tenant application 304d transmits the request 318 to a downstream computing infrastructure 322. Specifically, the tenant application 304d may use a network 332 to transmit the request 318 to a server 320 of the computing infrastructure 322. The request 318 may include the data retrieved by the tenant application 304b and the data retrieved by the tenant application 304c. The request 318 may also identify a machine learning model 324 and request the server 320 to transmit the data and execute the machine learning model 324.

The server 320 may evaluate the request 318 using various predefined rules and protocols. For instance, the metadata included within the request 318 may indicate an identifier of the tenant application 304a. The server 320 may evaluate the identifier to ensure that the tenant application 304d is authorized to access the machine learning model 324. The server 320 may also evaluate other metadata included within the request 318 to ensure that the data to be transmitted to the machine learning model 324 complies with defined security and compliance protocols.

Based on its evaluation, the server 320 may determine whether the request 318 should be authorized or blocked. For instance, a particular compliance protocol of the computing infrastructure 322 may prohibit the machine learning model 324 to ingest personally identifiable information of customers. In that example, the server 320 may block the request 318 because the request 318 includes personally identifiable customer information.

In conventional systems, the server 320 will have no context regarding the request 318. For instance, the server 320 may only be able to evaluate the tenant application 304d, as this is the tenant application that issued/transmitted the request 318. This is, at least in part, because the downstream computing infrastructure 322 is a disparate computing system that has been intentionally separated from the downstream computing infrastructure 302.

Using the methods discussed herein, the server 308 can improve the evaluation of the request 318, such that the server 320 can use a comprehensive approach.

Using the methods and systems discussed herein, the server 308 can ensure secure communication between the tenants 304 and a downstream computing infrastructure 322 is established. Specifically, using the methods discussed herein, the server 308 can allow for secure evaluation of requests received by the downstream computing infrastructure 360.

The server 308 may continuously monitor the communications among tenant applications 304. For instance, the server 308 may use the API 310 to monitor the requests and other data transmitted among different tenant applications. As depicted, the API 310 may be in communication with APIs 306. As a result, the server 308 may identify the requests 312, 314, and 316 as they are being transmitted among different tenant applications.

When the server 308 determines that the tenant application 304d has issued the request 318 to the downstream computing infrastructure 322, the server 308a generated a data packet 326 using the previously monitored data. In some embodiments, the server 308 may examine the request 318 in order to determine previous pertinent requests as well. As discussed herein, the server 308 may generate the data packet 326 in order to allow the server 320 to generate an informal evaluation regarding the request 318. Therefore, the data packet 326 may include contextual data associated with the request 318.

The server 308 may include various contextual data within the data packet 326. The data packet 326 may include a chain of events associated with the request 318 before the request 318 was issued by the tenant application 304d. For example, the data packet 326 may include an identifier of the tenant application 304a, 304b, and 304c. In some embodiments, the data packet 326 may include a description of each tenant application involved within the chain of events. For instance, the data packet 326 may indicate that the tenant application 304a is a software module configured to determine transaction fraud, the tenant application 304b is a software module configured to retrieve customer information, and that the tenant application 304c is a software module configured to retrieve merchant data.

The data packet 326 may also include identifiers of databases accessible to each tenant application 304. For instance, the data packet 326 may indicate that the tenant application 304b has access to customer PII, however, the tenant application 304c is not authorized to access any customer PII.

The data packet 326 may also include data associated with the requests 312 and 314. In some embodiments, the data packet 326 may indicate a time stamp associated with each request, the purpose of each request, the issuing a recipient entity of each request, and any other data associated with each request. For instance, the data packet 326 may indicate that the request 312 was issued at the time that the transaction request was received by the tenant application 304a (e.g., time stamp 11:02 AM).

The data packet 326 may also include a purpose of each request. For instance, data packet 326 may indicate that the request 312 issued at 11:02 AM was sent to the recipients (the tenant application 304b) to query 5 databases (including an identifier associated with each database) and retrieve customer profile information. Moreover, data associated with the request 318 can also be included within the data packet 326. For instance, the data packet 326 may also include an identifier of the request 318, such that the server 320 can determine that the data packet 326 was related to request 318.

After generating the data packet 326, the server 308 may transmit the data packet 326 to the downstream computing infrastructure 322 (the server 320). In some embodiments, such as a depicted embodiment, the server 308 may transmit the data packet 326 synchronously with the request 318. That is, the server 308 may transmit the data packet 326 in real-time or near real-time when the server 308 receives an indication that the request 318 has been transmitted to the server 320. Alternatively, the data packet 326 can be batched with other data packets or other requests and periodically transmitted to the appropriate downstream computing infrastructures.

In some embodiments, the server 308 may transmit the data packet 326 using a different electronic communication channel than used to transmit the request 318. As depicted, the tenant 30d may use the network 332 to transmit the request 318. In order to ensure security and reduce the risk of tampering with the data packet 326, the server 308 may use another network (e.g., a private network, such as the network 328). In some embodiments, the server 308 may use a designated API when communicating with downstream computing infrastructures. For instance, as depicted, the server 308 may use the API 330 to communicate with the server 320 and transmit the data packet 326. The API 330 may be designated for data packet communications and intentionally isolated from communicating with the tenant applications 304. As depicted, the server 308 may use different APIs for different purposes in order to increase network security.

After receiving the data packet 326, the server 320 may evaluate the data packet 326 and match an identifier included within the data packet 326 with the request 318. Using the data included within the data packet 326 in conjunction with the data included within the request 318, the server 320 may determine whether to authorize or block the request 318. If blocked, the server 320 may transmit a notification back to the server 308 that includes details regarding why the request 318 was blocked. For instance, the downstream computing infrastructure may dictate that the machine learning model 324 should not ingest any personally identifiable information. As a result, the server 320 may reject the request 318 because the data packet 326 indicated that the request 312 requested an upstream tenant application (specifically, the tenant application 304b) to retrieve personally identifiable information of customers. If, on the other hand, the server 320 authorizes the request 318, the server 320 may use the data within the request 318 to execute the machine learning model 324 and predict a likelihood of fraud for the transaction being evaluated by the tenant application 304a. The server 320 may then transmit the response back to the tenant 304d, which will, in turn, communicate with the tenant application 304a.

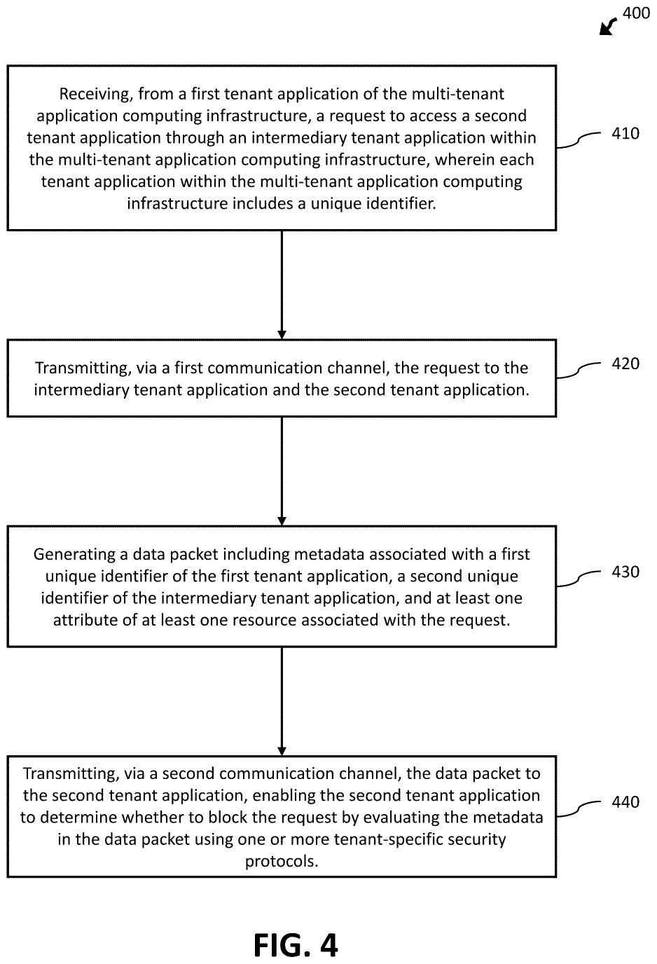

FIG. 4 provides a detailed explanation of a method for secure communication between tenant applications, such as shown in FIGS. 1-2. More specifically, FIG. 4 is a flowchart of an example method 400 (e.g., a secure communication method) for ensuring appropriate access for different tenant applications within a multi-tenant computing infrastructure, according to at least one embodiment of the methods and systems described herein. The method 400 may include steps 410-440. In some embodiments, the method 400 may include more or fewer steps than those illustrated in FIG. 4. In some embodiments, the method 400 may include one or more alternative steps not illustrated in FIG. 2.

The steps 410-440 of method 400 may be partially or wholly executed by one or more electronic devices (e.g., servers, user devices, processing circuitry, etc.), such as those shown in FIGS. 1-2. In at least one exemplary embodiment, the method 400 may be used by a server, such as the server 120d or 210d, to allow for secure access to one or more nodes/tenants of a computing infrastructure. For instance, in some embodiments, one or more tenant applications can securely grant access to a database using the method 400. Using the method 400, a server hosting a multi-tenant computing infrastructure can block fraudulent requests or enable a node/tenant to block the request received from different tenant applications, whether inside or outside the multi-tenant computing infrastructure.

Implementing the method 400 can eliminate the need for repetitive security checks across tenant applications (as required by conventional paradigms) by centralizing access control through the data packet, which contains the necessary data for a downstream tenant/computing infrastructure to evaluate a request. This centralized approach conserves processing resources, reduces latency, and simplifies compliance management in multi-tenant environments.

At step 410, the server may receive, from a first tenant application of the multi-tenant application computing infrastructure, a request to access a second tenant application through an intermediary tenant application within the multi-tenant application computing infrastructure, wherein each tenant application within the multi-tenant application computing infrastructure includes a unique identifier.

The server may host a multi-tenant application computing infrastructure that includes multiple tenant applications and/or nodes. Non-limiting examples of the multi-tenant application computing infrastructures are presented in FIGS. 1-2. The server may receive a request from a first-tenant application to access a second-tenant application.

As used herein, the “request” may refer to an electronic communication initiated by a first tenant application within the multi-tenant application computing infrastructure, seeking access to data, services, or processing capabilities managed by a second tenant application. The request can include various forms of data related to the operations requested by the first tenant application. For instance, the request may include reading, writing, or executing permissions, as well as any parameters required to perform the requested operation. In a non-limiting example, the request may indicate that a tenant application is requesting to write certain data onto a database. The request may also include the type of data being written onto the database (e.g., account identifier). The request may also include an indication that the account identifier is PII. In another example, if the first tenant application needs to query data managed by the second tenant application, the request may specify the type and scope of data required, any access rights validation needed, and operational parameters like time constraints or data formatting requirements.

In some embodiments, the request may necessitate one or more intermediary tenant applications'involvement to perform specific actions. For instance, the first tenant may issue a request for a destination tenant application to execute a machine learning model to determine whether a network operation (e.g., a transaction) is fraudulent. The machine learning model may require certain data that is queried from an intermediary tenant application. Therefore, the request issued may include the requested data, format requirement, and an indication of the intermediary tenant application that can perform the data query and formatting. The request will then be transmitted to the intermediary tenant application so that the intermediary tenant application can query and format the data and then transmit the data to the destination tenant application.

In addition to carrying out the intended operation, the request may also encapsulate identifying metadata associated with the originating tenant application, including its unique identifier. The unique identifier, once processed by the server, can provide for monitoring, logging, and evaluating the request in accordance with tenant-specific access policies.

At step 420, the server may transmit, via a first communication channel, the request to the intermediary tenant application and the second tenant application.

The server may transmit the request from the originating tenant application to both the intermediary tenant application and a second tenant application via a first communication channel. The first communication channel may be configured to carry the core content of the request, enabling direct interactions between tenant applications as the request progresses through the multi-tenant computing infrastructure.

At step 430, the server may generate a data packet including metadata associated with a first unique identifier of the first tenant application, a second unique identifier of the intermediary tenant application, and at least one attribute of at least one resource associated with the request.

In some embodiments, the server may generate a data packet containing metadata that includes a first unique identifier corresponding to the originating tenant application, a second unique identifier corresponding to the intermediary tenant application, and at least one attribute associated with a resource relevant to the request. The server may generate the data packet to provide downstream applications with a comprehensive context for processing and assessing the request. The first unique identifier (included within the data packet) may allow the downstream applications or systems to trace the origin of the request back to the originating tenant application. This enhances visibility when evaluating the request and enables fine-grained access control.

The inclusion of the second unique identifier, associated with the intermediary tenant application, may enable tracking of the request's full path, which then indicates the request's routing history (e.g., a chain of a request). Additionally, the data packet may include at least one attribute associated with a resource relevant to the request. This attribute may define characteristics such as the type of resource (e.g., data type, database, or storage location), sensitivity level (e.g., whether the request includes or is associated with any PII), or access permissions.

The metadata included within the data packet includes identifiers and resource attributes that provide the second tenant application with sufficient context to conduct a security assessment. In some embodiments, the content of the data packet may be encrypted so that it is only accessible to the destination tenant application.

In some embodiments, the data packet can be updated at runtime. For instance, the server may continuously monitor the activities performed by the first tenant application and the intermediary tenant application. The server may then update the data packet in real-time or in near real-time.

At step 440, the server may transmit, via a second communication channel, the data packet to the second tenant application, enabling the second tenant application to determine whether to block the request by evaluating the metadata in the data packet using one or more tenant-specific security protocols.

The server may transmit the data packet to the second tenant application via a second communication channel. This second communication channel may be dedicated to securely transmitting contextual information and may not be used by any of the tenant applications to communicate. For instance, the second communication channel may be a designated API that is used for parallel communication with destination tenant applications. Therefore, the second communication channel may be separated from the first communication channel on purpose in order to ensure that pertinent data is not inappropriately tampered with. In this way, the server can isolate sensitive contextual information from primary data flows. This isolation in electronic communication reduces the risk of data tampering or interception and further ensures that security and compliance protocols can be dynamically applied at each stage of a multi-tenant request, increasing operational efficiency.

Transmitting the data packet (having a path history, unique tenant identifiers, and resource attributes), enables precise security enforcement tailored to each tenant's requirements. Specifically, the data packet discussed herein provides visibility into issued request origins and paths.

The data packet may also include an identifier associated with the request, such that the destination tenant application (second tenant application) can identify which data packet matches with which request.

Upon receipt of the data packet, the second tenant application may identify a matching request. The second tenant application may then evaluate the request in light of the metadata included within the data packet. The second tenant application may analyze the metadata using one or more tenant-specific security protocols to verify the request. If the metadata evaluation reveals any compliance or security issues, the second tenant application may block the request, thereby preventing unauthorized or non-compliant access to its resources. This process enables the second tenant application to make informed access control decisions based on comprehensive, tenant-specific contextual information delivered through the second communication channel.

The data packet can be transmitted in real-time (at the same time as the request) or near real-time. Otherwise, the data packet may include a timestamp associated with the transmittal of the request, such that the destination tenant application can identify the matching/corresponding request based on the timestamp included within the data packet. Additionally, or alternatively, the data packet can be transmitted in batches at a later time. In some embodiments, the sensitivity level may dictate when the data packet is transmitted. For instance, a request may indicate that the performance is urgently requested. As a result, the data packet may be transmitted in real-time or near real-time. Otherwise, for non-urgent requests, the data packet may be bundled with other packets and transmitted to the destination tenant application.

The server may also forward the request to one or more tenant applications that may or may not be within the same computing environment. For instance, as depicted in FIG. 2, the server may forward the request and/or the data packet to another tenant that belongs to a separate computing environment.

In addition to forwarding the request, the server may also generate a log so that the log can be audited retroactively. For instance, the log can include the metadata associated with the request and the data packet. The log can also include pertinent time stamps. The log can then be uploaded in batches so that another computing entity can review the logs.

In some embodiments, the server may annotate tenant requests with metadata at runtime, capturing information such as the tenant's identity, purpose, and permissions. When a tenant application sends a request to downstream systems, this metadata can be included in a data packet that is transmitted alongside the main request using a separate side channel. Downstream systems, equipped with handlers that interpret these annotations, can then evaluate the metadata included within the data packet and relay it to security and compliance modules, if needed. This paradigm allows downstream systems to distinguish between tenants within the shared infrastructure and apply tenant-specific security and compliance controls as needed.

The server and/or the handlers may also be designed to propagate the tenant metadata and the data packet across multiple systems. For instance, if Tenant A within a multi-tenant infrastructure sends a request to System B, which then forwards it to System C, the metadata from Tenant A can be included in each step of the request's path, providing consistent and comprehensive tenant information at every stage. This ensures that security and compliance protocols specific to each tenant are applied at every hop, allowing continuous enforcement of access controls throughout the request's journey.

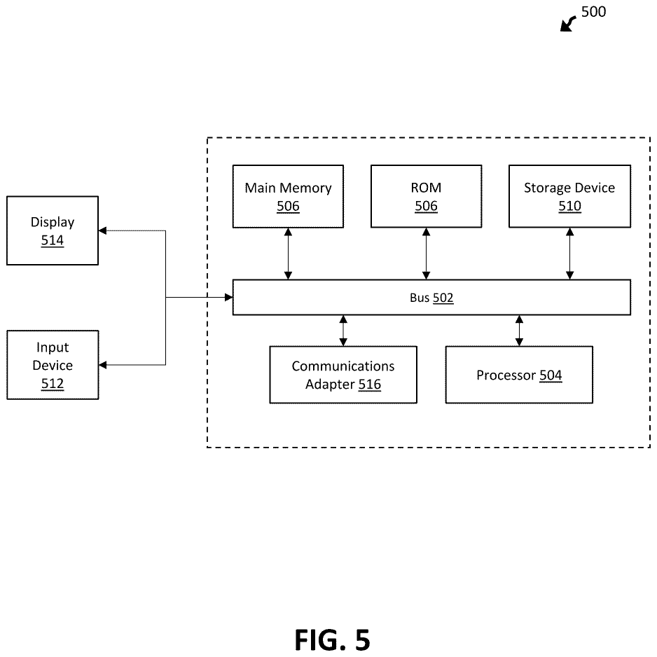

FIG. 5 is a component diagram of an example computing system 500 suitable for use in the various implementations described herein, according to an example embodiment. One or more steps of the methods and processes discussed herein can be performed by the computing system 500 depicted in FIG. 5. The computing system 500 includes a bus 502 or other communication component for communicating information and a processor 504 coupled to the bus 402 for processing information. The computing system 500 also includes main memory 506, such as a RAM or other dynamic storage device, coupled to the bus 502 for storing information, and instructions to be executed by the processor 504. Main memory 506 can also be used for storing position information, temporary variables, or other intermediate information during the execution of instructions by the processor 504. The computing system 500 may further include a ROM 508 or other static storage device coupled to the bus 502 for storing static information and instructions for the processor 504. A storage device 505, such as a solid-state device, magnetic disk, or optical disk, is coupled to the bus 502 for persistently storing information and instructions.

The computing system 500 may be coupled via the bus 502 to a display 514, such as a liquid crystal display, or active-matrix display, for displaying information to a user. An input device 512, such as a keyboard including alphanumeric and other keys, may be coupled to the bus 502 for communicating information, and command selections to the processor 504. In another implementation, the input device 512 has a touchscreen display. The input device 512 can include any type of biometric sensor, or a cursor control, such as a mouse, a trackball, or cursor direction keys, for communicating direction information and command selections to the processor 404 and for controlling cursor movement on the display 514.

In some implementations, the computing system 500 may include a communications adapter 516, such as a networking adapter. Communications adapter 516 may be coupled to bus 502 and may be configured to enable communications with a computing or communications network or other computing systems. In various illustrative implementations, any type of networking configuration may be achieved using communications adapter 516, such as wired (e.g., via Ethernet), wireless (e.g., via Wi-Fi, Bluetooth), satellite (e.g., via GPS) pre-configured, ad-hoc, LAN, WAN, and the like.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means, including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a computer-readable non-transitory medium or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What we claim is:

1. A method for enabling blocking fraudulent requests in multi-tenant application computing infrastructure, the method comprising:
receiving, by at least one processor hosting a multi-tenant application computing infrastructure, from a first tenant application of the multi-tenant application computing infrastructure, a request to access a second tenant application through an intermediary tenant application within the multi-tenant application computing infrastructure, wherein each tenant application within the multi-tenant application computing infrastructure includes a unique identifier;
transmitting, by the at least one processor via a first communication channel, the request to the intermediary tenant application and the second tenant application;
generating, by the at least one processor, a data packet including metadata associated with a first unique identifier of the first tenant application, a second unique identifier of the intermediary tenant application, and at least one attribute of at least one resource associated with the request; and
transmitting, by the at least one processor via a second communication channel, the data packet to the second tenant application, enabling the second tenant application to determine whether to block the request by evaluating the metadata in the data packet using one or more tenant-specific security protocols.

2. The method of claim 1, further comprising:
forwarding, by the processor, the data packet to at least one subsequent tenant application accessed by the first tenant application via the request.

3. The method of claim 1, further comprising:
generating, by the processor, a compliance log comprising the data packet and at least one action executed by the first tenant application.

4. The method of claim 1, wherein the data packet further comprises a sensitivity attribute associated with the first tenant application, and wherein the second tenant application blocks the first tenant application from accessing at least one resource in accordance with the sensitive attribute.

5. The method of claim 1, wherein the second tenant application is associated with a second multi-tenant application computing infrastructure.

6. The method of claim 1, wherein the data packet is dynamically updated at runtime, thereby allowing accommodation to real-time changes in tenant permission.

7. The method of claim 1, wherein the second communication channel is a secure application programming interface communication protocol that is not used by the tenant applications within the multi-tenant application computing infrastructure.

8. A computer system for enabling blocking fraudulent requests in multi-tenant application computing, the computer system comprising a computer-readable medium having instructions that when executed, cause a processor to:
receive from a first tenant application of a multi-tenant application computing infrastructure, a request to access a second tenant application through an intermediary tenant application within the multi-tenant application computing infrastructure, wherein each tenant application within the multi-tenant application computing infrastructure includes a unique identifier;
transmit, via a first communication channel, the request to the intermediary tenant application and the second tenant application;
generate a data packet including metadata associated with a first unique identifier of the first tenant application, a second unique identifier of the intermediary tenant application, and at least one attribute of at least one resource associated with the request; and
transmit, via a second communication channel, the data packet to the second tenant application, enabling the second tenant application to determine whether to block the request by evaluating the metadata in the data packet using one or more tenant-specific security protocols.

9. The computer system of claim 8, wherein the instructions further cause the processor to forward the data packet to at least one subsequent tenant application accessed by the first tenant application via the request.

10. The computer system of claim 8, wherein the instructions further cause the processor to generate a compliance log comprising the data packet and at least one action executed by the first tenant application.

11. The computer system of claim 8, wherein the data packet further comprises a sensitivity attribute associated with the first tenant application, and wherein the second tenant application blocks the first tenant application from accessing at least one resource in accordance with the sensitive attribute.

12. The computer system of claim 8, wherein the second tenant application is associated with a second multi-tenant application computing infrastructure.

13. The computer system of claim 8, wherein the data packet is dynamically updated at runtime, thereby allowing accommodation to real-time changes in tenant permission.

14. The computer system of claim 8, wherein the second communication channel is a secure application programming interface communication protocol that is not used by the tenant applications within the multi-tenant application computing infrastructure.

15. A computer system for enabling blocking fraudulent requests in multi-tenant application computing, the computer system comprising:
a multi-tenant application computing infrastructure;
a processor configured to host the multi-tenant application computing infrastructure, the processor configured to:
receive from a first tenant application of the multi-tenant application computing infrastructure, a request to access a second tenant application through an intermediary tenant application within the multi-tenant application computing infrastructure, wherein each tenant application within the multi-tenant application computing infrastructure includes a unique identifier;
transmit, via a first communication channel, the request to the intermediary tenant application and the second tenant application;
generate a data packet including metadata associated with a first unique identifier of the first tenant application, a second unique identifier of the intermediary tenant application, and at least one attribute of at least one resource associated with the request; and
transmit, via a second communication channel, the data packet to the second tenant application, enabling the second tenant application to determine whether to block the request by evaluating the metadata in the data packet using one or more tenant-specific security protocols.

16. The computer system of claim 15, wherein the processor is further configured to forward the data packet to at least one subsequent tenant application accessed by the first tenant application via the request.

17. The computer system of claim 15, wherein the processor is further configured to generate a compliance log comprising the data packet and at least one action executed by the first tenant application.

18. The computer system of claim 15, wherein the data packet further comprises a sensitivity attribute associated with the first tenant application, and wherein the second tenant application blocks the first tenant application from accessing at least one resource in accordance with the sensitive attribute.

19. The computer system of claim 15, wherein the second tenant application is associated with a second multi-tenant application computing infrastructure.

20. The computer system of claim 15, wherein the data packet is dynamically updated at runtime, thereby allowing accommodation to real-time changes in tenant permission.
